(19) United States
(12) Patent Application Publication
(10) Pub. No.: US 2016/0082393 A1
(43) Pub. Date: Mar. 24, 2016

(54) SEPARATION OF HOMOGENEOUS CATALYSTS BY MEANS OF A MEMBRANE SEPARATION UNIT UNDER CLOSED-LOOP CONTROL

(71) Applicants: Markus PRISKE, Mobile, AL (US); Bart HAMERS, VG Horst (NL); Dirk FRIDAG, Haltern am See (DE); Robert FRANKE, Marl (DE); Markus RUDEK, Mobile, AL (US); Hans-Gerd LUEKEN, Marl (DE); EVONIK DEGUSSA GMBH, Essen (DE)

(72) Inventors: Markus PRISKE, Mobile, AL (US); Bart HAMERS, Horst (NL); Dirk FRIDAG, Haltern am See (DE); Robert FRANKE, Marl (DE); Markus RUDEK, Gremzach-Wyhlen (DE); Hans-Gerd LUEKEN, Marl (DE)

(21) Appl. No.: 14/890,821

(22) PCT Filed: Apr. 17, 2014
(86) PCT No.: PCT/EP14/57851

§ 371 Date: Nov. 12, 2015

(30) Foreign Application Priority Data
May 13, 2013 (DE) 10 2013 208 759.4

(51) Int. Cl. B01D 61/36

(52) U.S. Cl. CPC B01D 61/36; B01D 2311/14; B01D 2311/2696

(57) ABSTRACT

The invention relates to a method for separating a homogeneous catalyst out of a reaction mixture by means of at least one membrane separation unit, in which method: the reaction mixture coming from a reaction zone and containing the homogeneous catalyst is applied as a feed to the membrane separation unit; the homogeneous catalyst is depleted in the permeate of the membrane separation unit and enriched in the retentate of the membrane separation unit; and the retentate of the membrane separation unit is recirculated into the reaction zone. The invention addresses the problem of specifying a method for separating homogeneous catalyst out of reaction mixtures that simplifies the feeding of fresh catalyst into the reaction zone and avoids disruptions to the hydrodynamics within the reaction zone when the volumetric flow of the reaction mixture output from the reaction zone varies. This problem is solved in that both the retentate volumetric flow of the membrane separation unit and the retention of the membrane separation unit are kept constant by regulation.

The invention relates to a method for separating a homogeneous catalyst from a reaction mixture by means of at least one membrane separation unit in which the reaction mixture which contains the homogeneous catalyst and originates from a reaction zone is applied as feed to the membrane separation unit, in which the homogeneous catalyst is depleted in the permeate of the membrane separation unit and is enriched in the retentate of the membrane separation unit, and in which the retentate of the membrane separation unit is recycled into the reaction zone, and to a corresponding apparatus.

One method of this type is known from WO 2013/034690 A1.

Where a catalytic reaction is discussed here, this means a chemical reaction in which at least one reactant is converted to at least one product in the presence of a catalyst. Reactant and product are referred to collectively as reaction participants. The catalyst is essentially not consumed during the reaction, apart from typical ageing and breakdown phenomena.

The reaction is conducted in a locally delimited reaction zone. In the simplest case, this is a reactor of any design, although it may also be a multitude of reactors connected to one another.

If the reaction participants are constantly introduced into and withdrawn from the reaction zone, this is referred to as a continuous process. If the reaction participants are injected into the reaction zone and remain therein during the reaction without further addition of essential reactants and withdrawal of products, this is referred to as a batch process. The invention is applicable to both modes of performance.

The material withdrawn continuously or discontinuously from the reaction zone is referred to here as reaction mixture. The reaction mixture comprises at least the target product of the reaction. According to the industrial reaction regime, it may also comprise unconverted reactants, more or less desirable further conversion products or accompanying products from further reactions and/or side reactions, and solvents. In addition, the reaction mixture may also comprise the catalyst.

Catalytically conducted chemical reactions can be divided into two groups with regard to the physical state of the catalyst used: Mention should be made here firstly of the heterogeneously catalyzed reactions in which the catalyst is present in solid form in the reaction zone and is surrounded by reaction participants. In the case of homogeneous catalysis, in contrast, the catalyst is dissolved in the reaction mixture. Homogeneously dissolved catalysts are usually much more effective in catalytic terms than heterogeneous catalysts.

In any catalytically conducted reaction, it is necessary to separate the catalyst from the reaction mixture. The reason for this is that the catalyst is barely consumed during the reaction and can therefore be reused. Moreover, the catalyst is usually much more valuable than the product produced therewith. Catalyst loss should therefore be avoided if possible.

The catalyst separation can be accomplished in a technically simple manner in the case of heterogeneously catalysed reactions: The solid catalysts simply remains in the reaction zone, while the liquid and/or gaseous reaction mixture is drawn off from the reactor. The separation of the homogeneous catalyst from the reaction mixture is thus effected mechanically and directly within the reaction zone.

The separation of a homogeneous catalyst from a reaction mixture is, however, much more demanding, since the homogeneous catalyst is dissolved in the reaction mixture. A simple mechanical separation is therefore not an option. Consequently, in the case of homogeneously catalysed processes, the catalyst is withdrawn from the reaction zone dissolved in the reaction mixture and is separated from the reaction mixture in a separate step. The catalyst is generally separated outside the reaction zone. The separated catalyst is recycled into the reaction zone. Since the separation of homogeneous catalysts from reaction mixtures never succeeds to perfection—small catalyst losses have to be accepted—the loss of catalyst always has to be compensated for by addition of fresh catalyst.

Catalyst loss is understood in this connection to mean not just the migration of catalytically active material out of the plant but also the loss of catalytic activity: For instance, some reactions are conducted in the presence of highly effective but highly sensitive homogeneous catalyst systems, for example organometallic complexes. The metal present in the catalyst system can be separated virtually completely and retained in the plant. However, the complex is destroyed easily in the event of improper separation, and so the retained catalyst becomes inactive and hence unusable.

The separation of homogeneously dissolved catalyst systems from reaction mixtures with minimum loss of material and activity is therefore a demanding task in chemical engineering.

This task arises especially in the field of rhodium-catalysed hydroformylation.

Hydroformylation—also called the oxo process—enables reaction of olefins (alkenes) with synthesis gas (mixture of carbon monoxide and hydrogen) to give aldehydes. The aldehydes obtained then correspondingly have one carbon atom more than the olefins used. Subsequent hydrogenation of the aldehydes gives rise to alcohols, which are also called “oxo alcohols” because of their genesis.

In principle, all olefins are amenable to hydroformylation, but in practice the substrates used in the hydroformylation are usually those olefins having two to 20 carbon atoms. Since alcohols obtainable by hydroformylation and hydrogenation have various possible uses—for instance as plasticizers for PVC, as detergents in washing compositions and as odourants—hydroformylation is practised on an industrial scale.

Important criteria for distinction of industrial hydroformylation processes are, as well as the substrate used, the catalyst system, the phase division in the reactor and the technique for discharge of the reaction products from the reactor. A further aspect of industrial relevance is the number of reaction stages conducted.

In industry, either cobalt- or rhodium-based catalyst systems are used, the latter being complexed with organophosphorus ligands such as phosphine, phosphite or phosphoramidite compounds. These catalyst systems are all present in the form of a homogeneous catalyst dissolved in the reaction mixture.

The hydroformylation reaction is usually conducted in biphasic mode, with a liquid phase comprising the olefins, the dissolved catalyst and the products, and a gas phase which is formed essentially by synthesis gas. The products of value are then either drawn off from the reactor in liquid form (“liquid recycle”) or discharged with the synthesis gas in gaseous form (“gas recycle”). This invention cannot be applied to gas recycle processes. A special case is the Ruhrchemie/Rhone-Poulenc process, in which the catalyst is present in an aqueous phase.

Some hydroformylation processes are also conducted in the presence of a solvent. These are, for example, alkanes present in the starting mixture.

Since the invention is concerned essentially with the separation of the homogeneous catalyst from the reaction mixture, reference is made to the extensive prior art with regard to the chemistry and reaction methodology of hydroformylation. It is worth reading the following in particular:
Falbe, Jürgen: New Syntheses with Carbon Monoxide. Springer, 1980 (standard work relating to hydroformylation)
Pruett, Roy L.: Hydroformylation. Advances in Organometallic Chemistry. Vol. 17, pages 1 to 60, 1979 (review article)
Frohning, Carl D. and Kohlpaintner, Christian W.: Hydroformylation (Oxo Synthesis, Roelen Reaction). Applied homogeneous catalysis with organometallic compounds. Wiley, 1996, pages 29 to 104 (review article)
Van Leeuwen, Piet W .N. M and Claver, Carmen (Edit.): Rhodium Catalyzed Hydroformylation. Catalysis by Metal Complexes. Volume 22. Kluwer, 2000 (Monograph relating to Rh-catalysed hydroformylation. Emphasis on chemistry, but chemical engineering aspects are also discussed.)
R. Franke, D. Selent and A. Börner: “Applied Hydroformylation”, Chem. Rev., 2012, DOI:10.1021/cr3001803 (overview of the current state of research).

A key factor for a successful, industrial-scale performance of Rh-based, homogeneously catalysed hydroformylations is the control of the catalyst separation.

One reason for this is that Rh is a very expensive noble metal, the loss of which should be avoided if possible. For this reason, the rhodium has to be separated substantially completely from the product stream and recovered. Since the Rh concentration in typical hydroformylation reactions is only 20 to 100 ppm and a typical “world scale” oxo process plant achieves an annual output of 200 000 tonnes, it is necessary to use separation apparatuses that firstly allow a large throughput and secondly reliably separate out the Rh, which is present only in small amounts. A complicating additional factor is that the organophosphorus ligands that form part of the catalyst complex are very sensitive to changes in state and are deactivated rapidly. In the best case, a deactivated catalyst can be reactivated only in a costly and inconvenient manner. The catalyst therefore has to be separated in a particularly gentle manner. A further important development aim is the energy efficiency of the separating operations.

The chemical engineer understands a separating operation to mean a measure in which a substance mixture comprising a plurality of components is converted to at least two substance mixtures, the substance mixtures obtained having a different quantitative composition from the starting mixture. The substance mixtures obtained generally have a particularly high concentration of the desired component, in the best case being pure products. There is usually a conflict, in terms of objectives, of purification level or separation sharpness with the throughput and the required apparatus complexity and the energy input.

Separation processes can be divided according to the physical effect utilized for the separation. In the workup of hydroformylation mixtures, there are essentially three known groups of separation processes, namely adsorptive separation processes, thermal separation processes and membrane separation processes.

The first group of separation processes which are utilized in the purification of hydroformylation mixtures is that of adsorptive separation processes. Here, the effect of chemical or physical adsorption of substances from fluids in another liquid or solid substance, the adsorbent, is utilized. For this purpose, the adsorbent is introduced into a vessel and the mixture to be separated flows through it. The target substances conducted together with the fluid interact with the adsorbent and thus remain stuck to it, such that the stream leaving the adsorber has been depleted (purged) of the substances adsorbed. In industry, vessels filled with adsorbents are also referred to as scavengers. A distinction is made between reversible and irreversible adsorbers, according to whether the adsorber is capable of releasing the adsorbed material again (regeneration) or binds it irreversibly. Since adsorbers are capable of taking up very small amounts of solids from streams, adsorptive separation processes are particularly suitable for fine purification. However, they are unsuitable for coarse purification since the constant exchange of irreversible adsorbers or the constant regeneration of reversible adsorbers is costly and inconvenient for industrial purposes.

Since adsorptive separation processes are particularly suitable for separation of solids, they are ideally suited to separation of catalyst residues out of the reaction mixtures. Suitable adsorbents are highly porous materials, for example activated carbon or functionalized silica.

WO 2010/097428 A1 accomplishes the separation of catalytically active Rh complexes from hydroformylations by first passing the reaction mixture to a membrane separation unit and then feeding the already Rh-depleted permeate to an adsorption step.

Because of their separation characteristics, adsorptive separation processes are not utilized for separation of active catalyst in large amounts, but instead are used as more of a “policing filter” for retention, at the last instance, of catalyst material which could not be separated out of the reaction mixture by upstream separation measures.

For the continuous separation of homogeneous catalyst in large amounts, only thermal separation processes or membrane separation processes are an option.

The thermal separation processes include distillations and rectifications. The separation processes, which have been tried and tested on the industrial scale, utilize the different boiling points of the components present in the mixture, by evaporating the mixture and selectively condensing the evaporating components. In particular, high temperatures and low pressures in distillation columns lead to deactivation of the catalyst. A further disadvantage of thermal separation processes is the large energy input always required.

Membrane separation processes are much more energy-efficient: Here, the starting mixture is applied as a feed to a membrane having different permeability for the different components. Components which pass through the membrane particularly efficiently are collected as permeate beyond the membrane and conducted away. Components which are preferentially retained by the membrane are collected as retentate on this side and conducted away.

In membrane technology, different separation effects are manifested; not only are size differences in the components (mechanical sieving effect) utilized, but also dissolution and diffusion effects. The less permeable the separation-active layer of the membrane becomes, the more dominant the dissolution and diffusion effects become. An excellent introduction into membrane technology is given by:
Melin/Rautenbach: Membranverfahren, Grundlagen der Modul- und Anlagenauslegung [Membrane Processes, Principles of Module and System Design], Springer, Berlin Heidelberg 2004.

Details of the possible uses of membrane technology for workup of hydroformylation mixtures are given by
Priske, M. et al.: Reaction integrated separation of homogeneous catalysts in the hydroformylation of higher olefins by means of organophilic nanofiltration. Journal of Membrane Science, Volume 360, Issues 1-2, 15 Sep. 2010, Pages 77-83; doi:10.1016/j.memsci.2010.05.002.

A great advantage of the membrane separation processes compared to thermal separation processes is the lower energy input; however, in the case of membrane separation processes too, there is the problem of deactivation of the catalyst complex.

This problem was solved by the method described in EP 1 931 472 B1 for workup of hydroformylation mixtures, in which a particular partial carbon monoxide pressure is maintained in the feed, in the permeate and also in the retentate of the membrane. It is thus possible for the first time to use membrane technology effectively in industrial hydroformylation.

A further membrane-supported method for catalyst separation from homogeneously catalysed gas/liquid reactions, such as hydroformylations in particular, is known from WO 2013/034690 A1. The membrane technique disclosed therein is designed specially for the requirements of a jet loop reactor utilized as the reaction zone.

A membrane-supported separation of homogeneous catalyst out of hydroformylation mixtures is also described in the as yet unpublished German patent application DE 10 2012 223 572 A1. The membrane separation units disclosed therein include overflow circuits operated by circulation pumps and are fed from a buffer storage means. However, no closed-loop control of these plant components is apparent.

It is a specific disadvantage of membrane separation processes that this still comparatively young technology stands and falls with the availability of the membranes. Specific membrane materials suitable for the deposition of catalyst complexes are not yet available in large volumes. The separation of large stream volumes, however, requires very large membrane areas and a correspondingly large amount of material and high capital costs.

The advantages of adsorptive and thermal separation technology, and of membrane separation technology, are combined in the as yet unpublished patent application DE 10 2013 203 117 A1. By means of comparatively gentle operation of a thermal separation stage, a majority of the catalyst burden is separated from the reaction mixture. Virtually complete residual purification is accomplished by means of two membrane separation units. A scavenger is used as a policing filter. In order to lower the specific membrane areas and hence to reduce the material costs, the first membrane separation unit is executed as a “feed and bleed” system to a single overflow circuit. The second membrane separation unit, in contrast, is executed as a two-stage amplifier cascade and has several overflow circuits. The unpublished DE 10 2013 203 117 A1 also addresses the problem of interferences between the closed-loop control of the reactor and the closed-loop control of the catalyst separation.

Every continuously operated industrial system subject to external perturbations requires a closed-loop control system. This also applies to the industrial performance of chemical reactions. The reactions are run under very substantially steady-state and known conditions, such that the closed-loop control complexity is lower compared to machinery and vehicles. However, external perturbations occur here too in the form of variations in the composition of the starting mixture. Thus, the substrates of a hydroformylation may originate from varying sources if a plant for hydroformylation is not fed solely from one raw material source. Even if the plant is connected directly to a single raw material source, for instance to a cracker for mineral oil, the reactant mixture delivered by the cracker may vary in terms of its composition if the cracker is run differently as a function of the raw material demand. The composition of the synthesis gas used is also subject to changes in industrial practice. This is the case especially when the synthesis gas is obtained from waste substances originating from varying sources.

The variable starting mixtures in the oxo process lead to variations in conversion and hence also to varying proportions of heterogeneous synthesis gas in the liquid reaction phase. Thus, there is also a variation in the volume flow rate of the reaction mixture discharged from the reaction zone. These variations in the volume flow rates can also be caused by stirrer units and pumps, as used, for example, in stirred tank reactors and stirred tank cascades. In bubble column reactors or jet loop reactors, perturbations in the hydrodynamics within the reactor can cause variations in discharge volume. Since the concentration of the homogeneous catalyst dissolved in the liquid phase is always the same, the result will also be that a varying (molar or weight-based) amount of catalyst is drawn off from the reaction zone. In order to keep the total amount of catalyst in the reaction zone constant, compensation by the addition of fresh catalyst is required. The closed-loop control of the addition of the fresh catalyst, however, is very complex in technical terms, since the catalyst content in the reactor can be determined only with difficulty and fresh catalyst is added manually.

Non-steady-state supply of synthesis gas also complicates the separation of the catalyst from the reaction mixture because compliance with a minimum partial CO pressure during the membrane separation is of inherent importance for maintenance of the catalyst activity (EP 1 931 472 B1).

An additional factor is that a varying feed volume flow rate affects the separation performance of the membrane—called the retention. Thus, it has been observed that the retention of a membrane is not a constant, but is dependent on the operating conditions within the membrane separation stage. Relevant operating parameters here include the transmembrane pressure, the overflow rate and the membrane temperature. These parameters, however, are influenced by the feed volume flow rate, such that variations in the volume flow rate of the incoming reaction mixture also affect the separation performance of the membrane. In the extreme case, this means that the retention of the membrane falls with rising volume flow rate, such that a particularly large amount of catalyst is lost.

Not only do varying operating conditions in the reactor have an unfavourable effect on the separation in the membrane separation stage, but there is also, conversely, a negative feedback effect:

When the retention of the membrane varies, this also leads to a varying retentate volume flow rate. Since the retentate of the membrane separation unit is recycled into the reaction zone, the reaction does not receive a constant return flow from the catalyst separation; instead, it is subject to the variations in the recyclate. This firstly complicates the closed-loop control of the catalyst content in the reactor by fresh catalyst addition; secondly, the hydrodynamics within the reactor are perturbed, these having a crucial influence on the conversion of the reactants in gas/liquid phase reactions.

In the light of this prior art, the problem addressed by the invention is that of specifying a method for separating homogeneous catalyst from reaction mixtures, which simplifies the addition of fresh catalyst and avoids perturbations in the hydrodynamics within the reaction zone with varying volume flow rate of the reaction mixture discharged from the reaction zone.

This problem is solved by keeping both the retentate volume flow rate of the membrane separation unit and the retention of the membrane separation unit constant by closed-loop control.

The invention therefore provides a method for separating a homogeneous catalyst from a reaction mixture by means of at least one membrane separation unit in which the reaction mixture which contains the homogeneous catalyst and originates from a reaction zone is applied as feed to the membrane separation unit, in which the homogeneous catalyst is depleted in the permeate of the membrane separation unit and is enriched in the retentate of the membrane separation unit, in which the retentate of the membrane separation unit is recycled into the reaction zone, and in which both the retentate volume flow rate of the membrane separation unit and the retention of the membrane separation unit are kept constant by closed-loop control.

The invention is based, first of all, on the surprising finding that the retention of a membrane separation unit can be actively regulated.

Retention is a measure of the ability of a membrane separation unit to enrich a component present in the feed in the retentate, or to deplete it in the permeate.

The retention R is calculated from the molar proportion of the component in question on the permeate side of the membrane x_{P} and the molar proportion of the component in question on the retentate side of the membrane x_{R}, as follows:

R=1−x_{P}/x_{R}

These concentrations x_{P} and x_{R} should be measured directly on the two sides of the membrane, and not at the connections of a membrane separation unit.

The invention has now recognized that the retention can be adjusted technically by suitable measures that affect the operating conditions of the membrane separation unit and hence can be kept constant. Perturbations exerted by the reaction zone on the membrane separation unit can be compensated for, such that a high retention and hence low catalyst losses are ensured even under unfavourable operating conditions within the reaction zone.

Furthermore, the closed-loop control of the retentate volume flow rate leads to increasing consistency in the recyclate inflow into the reaction zone, such that the hydrodynamics of the reaction are not perturbed.

Finally, a constant retention and a constant retentate volume flow rate are also able to balance out the catalyst budget of the reaction zone, which significantly simplifies the metered addition of fresh catalyst.

Overall, the closed-loop control of the membrane separation unit described in detail hereinafter brings about a distinct improvement in the conduct of the process in the reaction zone and reduces catalyst losses.

In principle, the present invention is of interest for any reaction conducted by homogeneous catalysis with catalyst separation by means of membrane technology, in which perturbations from the reaction zone affect the catalyst separation. This is the case especially when the volume flow rate of the reaction mixture discharged from the reaction zone varies, which occurs in many gas/liquid reactions. The invention is thus preferably applied to those methods in which the volume flow rate of the reaction mixture discharged from the reaction zone varies, and which are especially gas/liquid reactions.

Where the volume of the reaction mixture discharged from the reaction zone varies with time to a high degree, it is advisable to smooth the variations in the volume flow rate before introduction into the catalyst separation. This is preferably effected by initially charging the reaction mixture discharged from the reaction zone in a buffer vessel from which, by means of a first conveying unit which is adjustable with respect to its conveying volume, the reaction mixture is supplied as feed to the membrane separation unit, the volume flow rate of the feed being regulated by adjustment of the conveying volume of the first conveying unit as a function of the fill level of the buffer vessel such that the volume flow rate is increased in the case of an elevated fill level and/or with rising fill level and the volume flow rate is reduced in the case of a reduced fill level and/or with falling fill level.

With the aid of the buffer vessel, significant variations in the volume flow rate are attenuated by feeding reaction mixture from the buffer vessel of the membrane separation unit as feed under fill level control by means of the first conveying unit: The fill level of the buffer vessel is the time integral of the volume flow rate of the reaction mixture. If there is a change in the volume flow rate, this change is also reflected in the change in the fill level. The aim of regulating the fill level is to keep the fill level of the buffer vessel constant. If the fill level of the buffer vessel exceeds a predefined value, or generally begins to rise, the conveying volume of the conveying unit is correspondingly increased, in order to draw off a greater amount from the buffer vessel in the direction of the membrane separation unit. In the reverse case—i.e. in the case of a low or falling fill level—the conveying output of the conveying unit is correspondingly lowered.

A crucial aspect of the present invention is the configuration of the retention of the membrane separation unit in an adjustable manner. This is achieved in the simplest case by influencing an internal overflow circuit in the membrane separation unit. A preferred development of the invention thus envisages that the membrane separation unit comprises an overflow circuit operated by a circulation pump.

In order to regulate the retention of the membrane separation unit, two different approaches are possible in principle, which can also be combined with one another in an advantageous manner:

For instance, the closed-loop control of the retention of the membrane separation unit can be effected at least partly via the closed-loop control of the temperature of the overflow circuit. This is because it has been found that the temperature of the overflow circuit influences the retention of the membrane separation unit. Through simple closed-loop control of the temperature of the overflow circuit, it is therefore possible to adjust the retention of the membrane separation unit.

As an alternative or in addition to the thermal regulation approach, the invention proposes accomplishing the closed-loop control of the retention of the membrane separation unit at least partly via the closed-loop control of the pressure within the Fcircuit. This is because it has been found that the transmembrane pressure—which is the difference between the retentate side and permeate side of the membrane—exerts a significant influence on the retention capacity of the membrane. In order to influence the transmembrane pressure, one option is to influence the pressure within the overflow circuit.

In addition, the closed-loop control of the pressure in the overflow circuit can be effected by reducing an adjustable flow resistance disposed in the permeate of the membrane separation unit in the event of elevated pressure. In this way, the load on the overflow circuit can be reduced via the membrane and said flow resistance.

In the case of reduced pressure in the overflow circuit, the invention proposes drawing off permeate from a closed-loop control storage means, which is fed by a portion of the permeate of the membrane separation unit, and conveying it either into the overflow circuit or into the buffer vessel. This closed-loop control approach is based on the idea of collecting a portion of the permeate of the membrane separation unit in a buffer storage means and using the collected permeate as a material for closed-loop control. This can be done in two ways: Either the collected permeate is conveyed directly into the overflow circuit, in order to increase the pressure in the overflow circuit. Alternatively, the collected permeate is conveyed into the fill level-regulated buffer vessel, which in turn causes the first conveying unit to convey a greater amount of material from the buffer vessel into the overflow circuit. Which of the two options is chosen depends ultimately on the pressure level of the collected permeate: If it is above the pressure in the buffer vessel, the latter can be filled with permeate by means of a simple valve. If the permeate, however, has already run through several membrane separation steps and experienced a large pressure drop in the process, one option is to pump the permeate from the closed-loop control storage means directly into the overflow circuit. For this purpose, a corresponding high-pressure pump is required.

A preferred development of the invention envisages the conveying of the permeate out of the closed-loop control storage means into the overflow circuit or into the buffer vessel by provision of a second conveying unit adjustable with respect to its conveying volume, the conveying volume of which is adjusted as a function of the pressure differential between the overflow circuit and the permeate of the membrane separation unit. The pressure differential between the overflow circuit and the permeate of the membrane separation unit corresponds to the transmembrane pressure, which has a crucial influence on the retention of the membrane. By adjusting the conveying volume as a function of the transmembrane pressure, the transmembrane pressure can be controlled with the aid of the second conveying unit.

It has already been mentioned that the two closed-loop control approaches relating to the overflow circuit, namely closed-loop pressure control and closed-loop temperature control, can be combined with one another. Very particular preference is given to a combination of a thermostatic closed-loop control method, which keeps the temperature of the overflow circuit constant, and closed-loop pressure control as described above. This is because closed-loop pressure control is much more dynamic than closed-loop temperature control and accordingly enables better closed-loop control quality. Since the temperature, however, also influences the retention, this influence should be suppressed by the thermostatic closed-loop control, in order to avoid interference between temperature variations and pressure variations.

In order to further improve the closed-loop control quality, it is advisable to keep the overflow rate constant within the overflow circuit of the membrane separation unit, with the aim of suppressing volumetric fluctuations.

This is achieved in the simplest case by establishing the overflow rate using a circulation pump adjustable in terms of its conveying volume, which imposes its flow rate on the overflow circuit. The conveying volume of the circulation pump is then adjusted as a function of the overflow rate.

As already explained above, the catalyst budget of the reaction zone is balanced by keeping both the retention of the membrane separation unit and the retentate volume flow rate constant. The volume flow rate of the retentate is preferably kept constant by means of an adjustable flow resistance disposed in the retentate, the flow resistance of which is adjusted as a function of the volume flow rate of the retentate.

The inventive closed-loop control concept is of excellent employability for catalyst separation from homogeneously catalysed gas/liquid phase reactions where varying gas content in the liquid phase of the reaction output can be expected in the course of performance thereof. These include the following reactions: oxidations, epoxidations, hydroformylations, hydroaminations, hydroaminomethylations, hydrocyanations, hydrocarboxyalkylation, aminations, ammoxidation, oximations, hydrosilylations, ethoxylations, propoxylations, carbonylations, telomerizations, metatheses, Suzuki couplings or hydrogenations.

Said reactions can run individually or in combination with one another within the reaction zone.

Very particular preference is given to employing the inventive closed-loop control concept, however, for the removal of an organometallic complex catalyst from a hydroformylation reaction, in which at least one substance having at least one ethylenically unsaturated double bond is reacted with carbon monoxide and hydrogen. In general, said substance is an olefin, which is converted to an aldehyde in the course of the hydroformylation.

If a hydroformylation is being conducted in the reaction zone, it is possible in principle to use any hydroformylatable olefins therein. These are generally those olefins having 2 to 20 carbon atoms. Depending on the catalyst system used, it is possible to hydroformylate either terminal or non-terminal olefins. Rhodium-phosphite systems can use either terminal or non-terminal olefins as substrate. Organometallic complex catalysts used are therefore preferably Rh-phosphite systems.

The olefins used need not be used as a pure substance either; instead, it is also possible to utilize olefin mixtures as reactant. Olefin mixtures should be understood to mean firstly mixtures of various isomers of olefins having a uniform number of carbon atoms; secondly, an olefin mixture may also include olefins having different numbers of carbon atoms and isomers thereof. Very particular preference is given to using olefins having 8 carbon atoms in the method, and therefore to hydroformylating them to aldehydes having 9 carbon atoms.

Very particular preference is given to using the invention for catalyst separation from homogeneously catalysed hydroformylation methods in which the metal catalyst has been modified by ligands. Very particular preference is given to separating, with the aid of the process according to the invention, catalyst complexes having mono- and polyphosphite ligands with or without added stabilizer. The present invention is applied with particular preference to such catalyst systems because such systems have a high tendency to be deactivated and therefore have to be separated in a particularly gentle manner. This is possible only with the aid of membrane separation technology.

The invention also provides an apparatus for performance of the method according to the invention. This apparatus comprises:
a) a reaction zone for preparation of a reaction mixture comprising a homogeneous catalyst;
b) a membrane separation unit for separation of the homogeneous catalyst from the reaction mixture to obtain a permeate depleted of homogeneous catalyst and a retentate enriched with homogeneous catalyst;
c) a catalyst return system for recycling of the retentate enriched with homogeneous catalyst into the reaction zone;
d) and means for closed-loop control of the retention and the retentate volume flow rate of the membrane separation unit.

The reaction zone is understood to mean at least one reactor for performance of a chemical reaction, in which the reaction mixture forms.

Useful reactor designs are especially those apparatuses which allow a gas/liquid phase reaction. These may, for example, be stirred tank reactors or stirred tank cascades. Preference is given to using a bubble column reactor. Bubble column reactors are commonly known in the prior art and are described in detail in Ullmann:
Deen, N. G., Mudde, R. F., Kuipers, J. A. M., Zehner, P. and Kraume, M.: Bubble Columns. Ullmann's Encyclopedia of Industrial Chemistry. Published Online: 15 Jan. 2010. DOI: 10.1002/14356007. b04_{—}275.pub2

Since the scale of bubble column reactors cannot be adjusted arbitrarily because of its flow characteristics, it is necessary in the case of a plant having very large production capacity to provide, rather than one single large reactor, two or more smaller reactors connected in parallel. Thus, in the case of a world-scale plant having an output of 30 t/h, it is possible to provide either two or three bubble columns each having a capacity of 15 t/h or 10 t/h. The reactors work in parallel under the same reaction conditions. The parallel connection of several reactors also has the advantage that, in the event of relatively low utilization of plant capacity, the reactor need not be run in the energetically unfavourable partial load range. Instead, one of the reactors is shut down completely and the other reactor continues to be run under full load. A triple connection can correspondingly react even more flexibly to changes in demand.

Thus, if a reaction zone is discussed here, this does not necessarily mean that only one apparatus is involved. A plurality of reactors connected to one another may also be meant.

A membrane separation unit is understood to mean an assembly of apparatuses or units or fittings which are utilized for separation of the catalyst from the reaction mixture. As well as the actual membrane, these are valves, pumps and further closed-loop control units.

The membrane itself may be configured in different module designs. Preference is given to the spiral-wound element.

Preference is given to using membranes having a separation-active layer of a material selected from cellulose acetate, cellulose triacetate, cellulose nitrate, regenerated cellulose, polyimides, polyamides, polyether ether ketones, sulphonated polyether ether ketones, aromatic polyamides, polyamide imides, polybenzimidazoles, polybenzimidazolones, polyacrylonitrile, polyaryl ether sulphones, polyesters, polycarbonates, polytetrafluoroethylene, polyvinylidene fluoride, polypropylene, terminally or laterally organomodified siloxane, polydimethylsiloxane, silicones, polyphosphazenes, polyphenyl sulphides, polybenzimidazoles, Nylon® 6,6, polysulphones, polyanilines, polypropylenes, polyurethanes, acrylonitrile/glycidyl methacrylate (PANGMA), polytrimethylsilylpropynes, polymethylpentynes, polyvinyltrimethylsilane, polyphenylene oxide, alpha-aluminas, gamma-aluminas, titanium oxides, silicon oxides, zirconium oxides, ceramic membranes hydrophobized with silanes, as described in EP 1 603 663 B1, polymers having intrinsic microporosity (PIM) such as PIM-1 and others, as described, for example, in EP 0 781 166 and in “Membranes” by I. Cabasso, Encyclopedia of Polymer Science and Technology, John Wiley and Sons, New York, 1987. The abovementioned substances may be present, especially in the separation-active layer, optionally in crosslinked form through addition of auxiliaries, or in the form of what are called mixed matrix membranes with fillers, for example carbon nanotubes, metal-organic frameworks or hollow spheres, and particles of inorganic oxides or inorganic fibres, for example ceramic fibres or glass fibres.

Particular preference is given to using membranes having, as a separation-active layer, a polymer layer of terminally or laterally organomodified siloxane, polydimethylsiloxane or polyimide, formed from polymers having intrinsic microporosity (PIM) such as PIM-1, or wherein the separation-active layer has been formed by means of a hydrophobized ceramic membrane.

Very particular preference is given to using membranes formed from terminally or laterally organomodified siloxanes or polydimethylsiloxanes. Membranes of this kind are commercially available.

As well as the abovementioned materials, the membranes may also include further materials. More particularly, the membranes may include support or carrier materials to which the separation-active layer has been applied. In such composite membranes, a support material is present as well as the actual membrane. A selection of support materials is described by EP 0 781 166, to which reference is made explicitly.

A selection of commercially available solvents for stable membranes are the MPF and Selro series from Koch Membrane Systems, Inc., different types of Solsep BV, the Starmem™ series from Grace/UOP, the DuraMem™ and PuraMem™ series from Evonik Industries AG, the Nano-Pro series from AMS Technologies, the HITK-T1 from IKTS, and also oNF-1, oNF-2 and NC-1 from GMT Membrantechnik GmbH and the inopor® nano products from Inopor GmbH.

The present invention will now be illustrated in detail by working examples. The figures show:

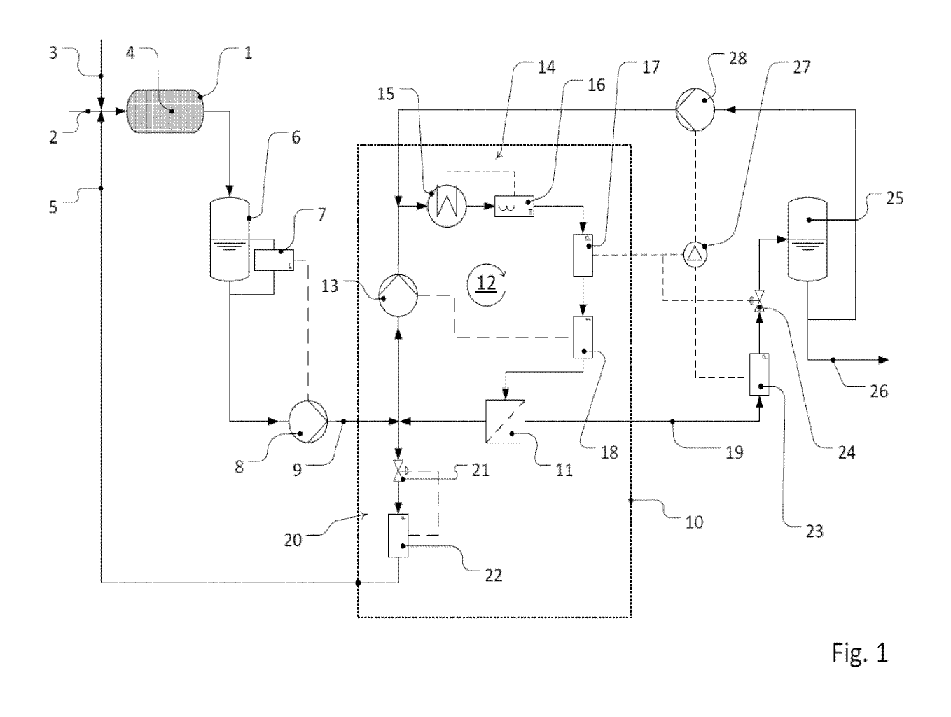

FIG. 1: Closed-loop control concept for a one-stage membrane separation with dosage of the permeate back into the overflow circuit;

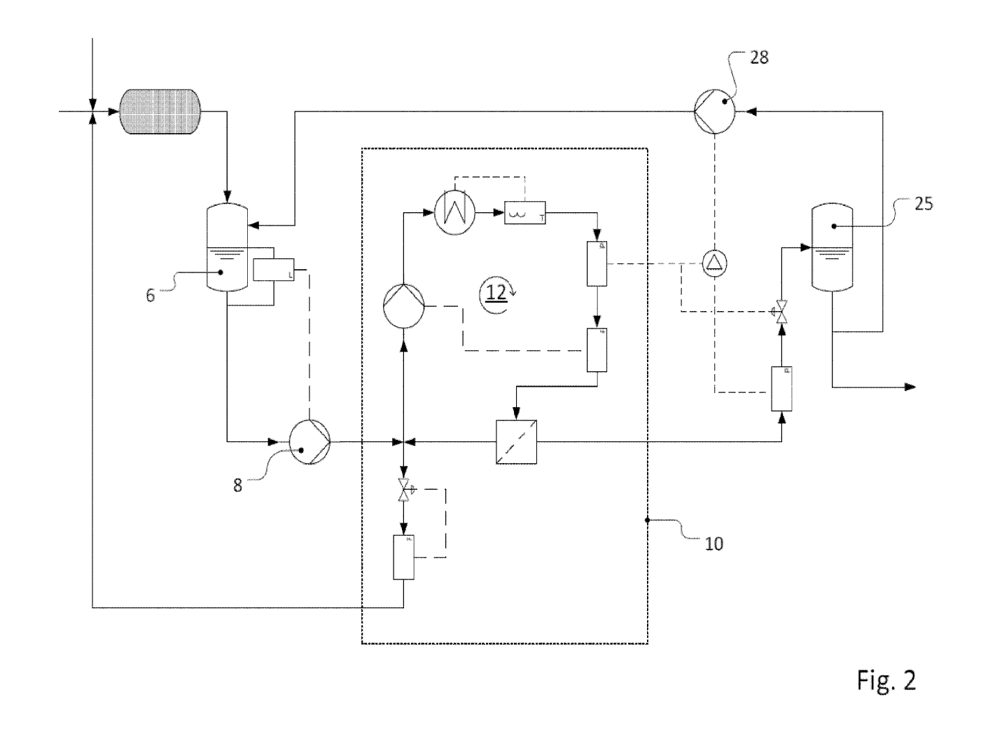

FIG. 2: Closed-loop control concept for a one-stage membrane separation with dosage of the permeate back into the buffer vessel;

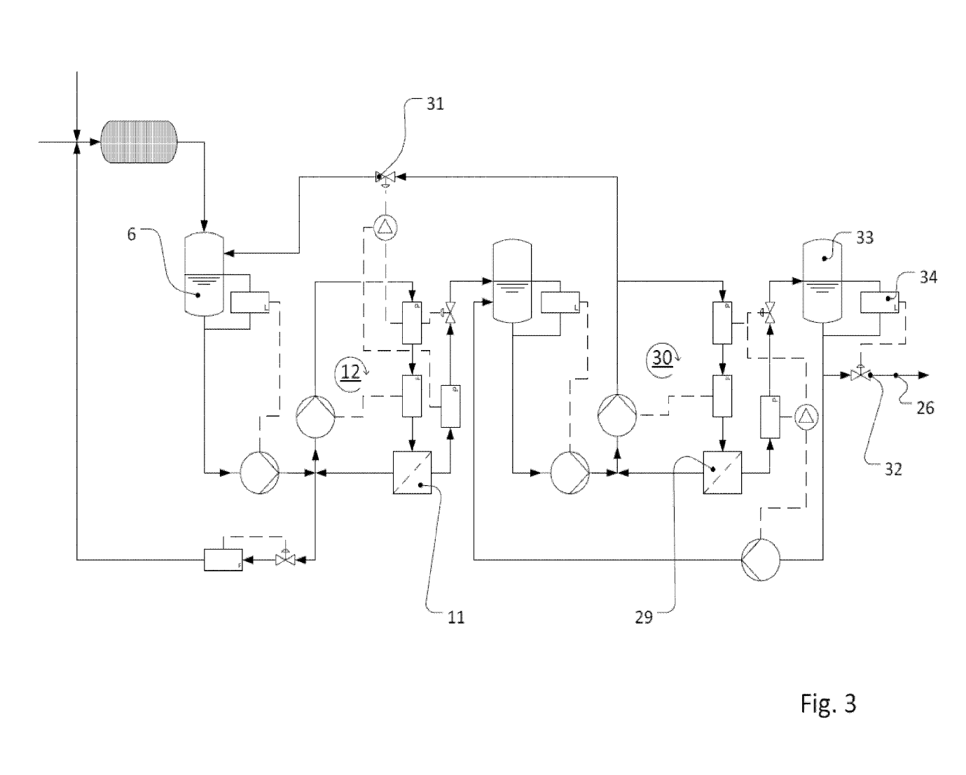

FIG. 3: Closed-loop control concept for a two-stage membrane separation with dosage of the permeate back into the overflow vessel and/or into the buffer vessel, and without thermostat.

FIG. 1 shows a first embodiment of the invention, embodied in a closed-loop control concept for a one-stage membrane separation. A reaction zone 1 is charged continuously with reactant 2. If a hydroformylation is being conducted within the reaction zone 1, the reactants are olefins and synthesis gas, and solvents in the form of alkenes accompanying the olefins. The reactants are in liquid and gaseous form; more particularly, the olefins and the solvent are fed into the reaction zone 1 in liquid form, while the synthesis gas is introduced in gaseous form. For the sake of simplicity, only one arrow representing the entirety of the reactants 2 is shown here.

To accelerate the reaction, fresh catalyst 3 is added to the reaction zone 1. The catalyst is dissolved homogeneously within the reaction mixture 4 present in the reaction zone 1. The liquid reaction mixture 4 is drawn off continuously from the reaction zone 1, but with a volume flow rate varying over time. A retentate 5, which will be elucidated in detail later, is recycled into the reaction zone 1. In order to attenuate the volumetric variations in the reaction mixture 4 drawn off from the reaction zone 1, the liquid reaction mixture 4 is first initially charged into a buffer vessel 6. If appropriate, gas components are removed beforehand from the liquid reaction mixture 4 (not shown).

The buffer vessel 6 has a closed-loop fill level control system 7, which continuously measures the fill level within the buffer vessel and keeps it constant within the region of a target value. This is accomplished by drawing off reaction mixture 4 continuously from the buffer vessel 6 by means of a first conveying unit 8 in the form of a pump. The first conveying unit 8 is adjustable in terms of its conveying volume flow rate. The conveying rate is adjusted by means of the closed-loop fill level control system 7: If the fill level within the buffer vessel 6 has exceeded the set target value, the conveying rate of the first conveying unit 8 is increased in order to reduce the fill level. Conversely, the closed-loop fill level control system 7 reduces the conveying volume flow rate of the first conveying unit 8 when the fill level within the buffer vessel 6 has fallen below the target value.

The closed-loop fill level control system 7 can also be operated in such a way that the conveying rate of the first conveying unit is increased as soon as the fill level rises, or is lowered if it falls. In this case, it is not the fill level that is the closed-loop control parameter, but the change in fill level with time. The change in the fill level with time corresponds essentially to the changing volume flow rate from the reaction zone 1, and so this closed-loop control parameter is preferred. However, closed-loop control of the fill level (corresponding to the time integral of the volume flow rate of the reaction mixture 4) is easier to implement in technical terms, and so this closed-loop control parameter too can be employed. It will be appreciated that it is also possible to exert closed-loop control over both closed-loop control parameters at the same time.

Overall, the closed-loop fill level control system 7 together with the first conveying unit 8 brings about increasing consistency in the feed 9 which is applied by the first conveying unit 8 to a membrane separation unit 10.

The membrane separation unit 10 is an assembly comprising a multitude of individual units and closed-loop control unit, which is described in detail hereinafter. At the heart of the membrane separation unit 10 is the actual membrane 11, where the homogeneous catalyst is separated from the reaction mixture. For this purpose, the reaction mixture 4 is fed as feed 9 into an internal overflow circuit 12 of the membrane separation unit 10. The overflow circuit 12 is operated by a circulation pump 13. The temperature of the material within the overflow circuit 12 is kept constant by a thermostat 14. The thermostat 14 comprises a heat exchanger 15 and a temperature regulator 16. If the temperature within the overflow circuit 12 falls below a set target value and/or begins to fall, the temperature regulator 16 causes the heat exchanger 15 to introduce heat from the outside into the overflow circuit 12 (not shown). In the reverse case, with excessively high and/or rising overflow temperature, the overflow circuit 12 is cooled by means of the heat exchanger 15. Keeping the temperature constant within the overflow circuit 12 contributes to a constant retention of the membrane separation unit 10.

The overflow circuit 12 then passes through an internal pressure gauge 17 and a first flow regulator 18 before it is applied to the actual membrane 11. The function of the internal pressure gauge 17 will be explained later; the flow regulator 18 serves to adjust the overflow flow rate (this is the overflow volume flow rate within the overflow circuit 12) with the aid of the circulation pump 13. The latter is likewise adjustable in terms of its conveying volume, the adjustment of the conveying volume being defined by the first flow regulator 18. If the overflow flow rate is too small and or begins to fall, the first flow regulator 18 causes the circulation pump 13 to set a greater conveying output, such that the overflow flow rate increases. If the overflow flow rate is too high and/or begins to rise, the flow regulator 18 lowers the conveying rate of the circulation pump 13.

Thermostat 14 and first flow regulator 18 ideally ensure that the flow through the membrane 11 is at constant volume flow rate and constant temperature.

The membrane 11 is of different permeability in terms of the different components of the feed thereof. For instance, the permeability of the membrane 11 for the homogeneously dissolved catalyst is lower than for the other components of the reaction mixture. The result of this is that the catalyst is enriched in the retentate 5 on this side of the membrane, whereas the concentration of the catalyst is depleted on the other side of the membrane, in what is called the permeate 19. The retentate 5, partly mixed with fresh feed 9, is recycled back into the overflow circuit 12. The remainder of the retentate 5 is drawn off from the membrane separation unit 10 by means of a volume flow regulator 20.

The volume flow regulator 20 comprises an adjustable flow resistance 21 disposed within the retentate, in the form of a valve, the flow resistance of which is adjusted by a second flow regulator 22. If the retentate volume flow rate falls below a preset value, this is detected by the second flow regulator 22 and converted to a reduction in the flow resistance 21, meaning that the valve 21 opens. If the retentate volume flow rate is too high, the flow resistance 21 is lowered by closing the valve. Particular preference is given here to using an equal-percentage valve as the flow resistor and a regulator with PID characteristics. The retentate 5 leaving the membrane separation unit 10 is recycled into the reaction zone 4 at virtually constant retentate volume flow rate.

The permeate 19 which likewise leaves the membrane separation unit 10 passes through an external pressure gauge 23 and a flow resistance 24 disposed in the permeate, and finally passes into a closed-loop control storage means 25. Via an outlet 26, the permeate 19 leaves the catalyst separation and is fed to a downstream product separation, not shown here. The product separation separates the product of value of the reaction conducted within the reaction zone 4 from the permeate. In this regard, reference is made particularly to the as yet unpublished patent application DE 10 2013 203 117 A1 or to EP 1 931 472 B1. Since the permeate 19 at the outlet 26 of the catalyst separation is very substantially free of catalyst constituents, the product separation can be effected without taking account of the stability of the catalyst under harsh conditions.

The permeate stream which leaves the catalyst separation via its outlet 26 is very substantially free of catalyst because the membrane separation unit is regulated such that the retention thereof is always within the optimal range. This is achieved particularly through the regulation of the transmembrane pressure Δp of the membrane separation unit, as will be described hereinafter.

The transmembrane pressure Δp is the pressure differential between the pressure on the feed or retentate side and the permeate side of the membrane. The pressure on the feed side, in the present closed-loop control concept, is measured by means of the internal pressure gauge 17, whereas the pressure on the permeate side is measured by means of the external pressure gauge 23. The differential, i.e. the transmembrane pressure, is determined by a differential regulator 27. The differential regulator 27 takes the pressure on the feed side in the overflow circuit 12 from the internal pressure gauge 17 and subtracts from it the pressure on the permeate side that it receives from the external pressure gauge 23.

In order to keep the transmembrane pressure Δp constant, the pressure within the overflow circuit 12 in particular is kept constant. If this pressure is too low, the differential regulator 27 causes a second conveying unit 28 to introduce permeate from the closed-loop control storage means 25 into the overflow circuit 12. The additional material (permeate) within the overflow circuit 12 causes a rise in the pressure in the overflow circuit 12, measured at the internal pressure gauge 17. The metering of the pressure is possible by virtue of the second conveying unit 28 being adjustable in terms of its conveying rate. This is because the second conveying unit 28 is a pump of adjustable speed. The conveying volume is directly proportional to the speed. Alternatively, the pump displacement could be adjusted, which leads to a change in conveying volume at a constant speed. As always, the conveying volume of the second conveying unit 28 is adjusted as a function of the pressure within the overflow circuit 12. In the case of elevated pressure within the overflow circuit 12, the conveying rate of the second conveying unit 28 is lowered.

Preferably, however, the flow resistance 24 in the permeate is reduced if the transmembrane pressure is too great. This promotes the flow of the permeate 19 out of the membrane separation unit 10, such that the transmembrane pressure Δp is adjusted correctly again. It is also possible to regulate the permeate volume flow rate via the flow resistance 24 in the permeate. The pressure within the overflow circuit 12 would then be adjusted solely via the second conveying unit 28.

The closed-loop control unit described here in the membrane separation unit is very substantially shielded from influences from the reaction zone 4, since an increased volume flow rate from the reaction zone 4 is firstly attenuated by means of the buffer vessel 6 and, in addition, a decrease in the conveying rate of the second conveying unit 28 is brought about. The two conveying units 8 and 28 thus work in opposing ways: If the first conveying unit 8 delivers a large amount of feed, the second conveying unit 28 recycles less permeate from the closed-loop control storage means 25. Correspondingly and conversely, a large amount of permeate is withdrawn from the closed-loop control storage means 25 by means of the second conveying unit 28 if little reaction mixture is delivered to the membrane separation unit 10 by means of the first conveying unit 8, because the fill level in the buffer vessel 6 is low.

FIG. 2 shows a second embodiment of the invention in the form of a modified closed-loop control concept. The second concept in FIG. 2 corresponds essentially to the first closed-loop control concept shown in FIG. 1. The difference is that the permeate conveyed back in from the closed-loop control storage means 25 by the second conveying unit 28 is not conveyed back into the overflow circuit 12, but back into the buffer vessel 6. This has the advantage over the embodiment shown in FIG. 1 that the second conveying unit 28 can work at a lower pressure level than the second conveying unit in the embodiment shown in FIG. 1. The second conveying unit 28 in the second embodiment is thus found to be much less expensive than that in the first embodiment. The pressure in the overflow circuit 12 in the second embodiment is thus imposed via the first conveying unit 8, which is executed as a high-pressure pump in both cases.

In the closed-loop control concept shown in FIG. 2, a falling pressure within the overflow circuit 12 brings about a more rapid rise in fill level within the buffer vessel 6, since the second conveying unit 28 transfers permeate from the closed-loop control storage means 25 into the buffer vessel 6. The closed-loop fill level control system 7 then causes the first conveying unit 8 to convey a greater amount of feed into the membrane separation unit 10.

A disadvantage of the second closed-loop control concept compared to the first closed-loop control concept is that it responds only in a delayed manner because of the intermediate buffer storage means 6. The closed-loop control of the transmembrane pressure in the first embodiment shown in FIG. 1 responds more “harshly”, since the permeate conveyed back in is injected directly into the overflow circuit 12.

FIG. 3 shows a third embodiment of the invention, which basically constitutes a combination of the two other embodiments. This is a two-stage membrane separation, in which a second membrane 29 is arranged beyond the first membrane 11. The pressure in the overflow circuit 12 of the first membrane 11 is regulated, in accordance with the second embodiment, by intermediate connection of the buffer vessel 6. This is likewise the case in the overflow circuit 30 of the second membrane 29. However, in the event of elevated pressure in the second overflow circuit 30 here, feed is withdrawn via a third conveying unit 31 in the form of a third flow resistance and recycled into the buffer vessel 6.

The permeate withdrawn via the outflow from the catalyst separation 26 is kept constant in terms of its volume flow rate by means of an outflow regulator 32, which regulates by means of a fill level regulator 34 disposed in the closed-loop control storage means 33 of the second membrane separation stage.

### LIST OF REFERENCE NUMERALS

1 reaction zone
2 reactant
3 fresh catalyst
4 reaction mixture
5 retentate
6 buffer vessel
7 closed-loop fill level control system
8 first conveying unit
9 feed
10 membrane separation unit
11 membrane
12 overflow circuit
13 circulation pump
14 thermostat
15 heat exchanger
16 temperature regulator
17 internal pressure gauge
18 first flow regulator
19 permeate
20 volume flow regulator
21 flow resistance in the retentate
22 second flow regulator
23 external pressure gauge
24 flow resistance in the permeate
25 closed-loop control storage means
26 outflow from the catalyst separation
27 differential regulator
28 second conveying unit
29 second membrane
30 overflow circuit of the second membrane
31 third conveying unit
32 outflow regulator
33 closed-loop control storage means of the second membrane separation stage
34 fill level regulator for the closed-loop control storage means of the second membrane separation stage

1. A method for separating a homogeneous catalyst from a reaction mixture, comprising:
feeding the reaction mixture, which originates from a reaction zone and comprises the homogeneous catalyst, to a membrane separation unit to obtain a permeate and a retentate, wherein the permeate is depleted of the homogeneous catalyst and the retentate is enriched in the homogeneous catalyst,
recycling the retentate into the reaction zone, and
keeping both a retentate volume flow rate of the membrane separation unit and a retention of the membrane separation unit constant with a closed-loop control unit.

2. The method according to claim 1, further comprising:
discharging the reaction mixture from the reaction zone at a volume flow rate which varies.

3. The method according to claim 2, further comprising:
filling a buffer vessel with the reaction mixture before feeding the reaction mixture to the membrane separation unit, and
regulating the volume flow rate of the reaction mixture to the membrane separation unit by adjusting a conveying volume of a first conveying unit, wherein the conveying volume is a function of a fill level of the buffer vessel, the volume flow rate is increased when the fill level is at least one of an elevated fill level and a rising fill level, and the volume flow rate is reduced when the fill level is at least one of a reduced fill level and a falling fill level.

4. The method according to claim 1, wherein the membrane separation unit further comprises:
an overflow circuit operated by a circulation pump.

5. The method according to claim 4, further comprising:
adjusting the retention with a closed-loop temperature control unit of the overflow circuit.

6. The method according to claim 4, further comprising:
adjusting the retention with a closed-loop pressure control unit of the overflow circuit.

7. The method according to claim 6, further comprising:
adjusting a first flow resistance valve to control the pressure in the overflow circuit, wherein the first flow resistance valve reduces a first flow resistance in the event of elevated pressure in the overflow circuit, and the first flow resistance valve is disposed in the permeate of the membrane separation unit.

8. The method according to claim 6, further comprising:
collecting a portion of the permeate of the membrane separation unit in a closed-loop control storage, and
conveying the portion of the permeate out of the closed-loop control storage into the overflow circuit or the buffer vessel with the closed-loop pressure control unit in the event of reduced pressure in the overflow circuit.

9. The method according to claim 8, wherein the conveying of the portion of the permeate out of the closed-loop control storage is effected by a second conveying unit with an adjustable conveying volume, which is adjusted as a function of a pressure differential between the overflow circuit and the permeate of the membrane separation unit.

10. The method according to claim 4, wherein an overflow flow rate is kept constant within the overflow circuit.

11. The method according to claim 10, further comprising:
adjusting a conveying volume of the circulation pump as a function of the overflow flow rate to keep the overflow flow rate constant.

12. The method according to claim 1, further comprising:
adjusting a second flow resistance as a function of the retentate volume flow rate with a second flow resistance valve to keep the retentate volume flow rate constant, wherein the second flow resistance valve is disposed in the retentate.

13. The method according to claim 1, wherein the reaction mixture further comprises:
a homogeneously catalyzed gas or liquid phase reaction, which is conducted in the reaction zone, wherein the homogeneously catalyzed gas or liquid phase reaction is at least one selected from the group consisting of an oxidation, an epoxidation, a hydroformylation, a hydroamination, a hydroaminomethylation, a hydrocyanation, a hydrocarboxyalkylation, an amination, an ammoxidation, an oximation, a hydrosilylations, an ethoxylation, a propoxylation, a carbonylation, a telomerization, a metathesis, a Suzuki coupling and a hydrogenation.

14. The method according to claim 13, wherein the reaction mixture further comprises:
a substance having an ethylene unsaturated double bond, wherein the substance reacts in a hydroformylation reaction with carbon monoxide and hydrogen in the presence of an organometallic complex catalyst.

15. An apparatus for performing the method of claim 1, the apparatus comprising:
the reaction zone for preparing the reaction mixture comprising the homogeneous catalyst;
the membrane separation unit for separating the homogeneous catalyst from the reaction mixture to obtain the permeate and the retentate;
a catalyst return system for recycling the retentate into the reaction zone; and
the closed-loop control unit for controlling both the retention and the retentate volume flow rate, wherein the reaction zone, the membrane separation unit, the catalyst return system and the closed-loop control unit are fluidly connected to one another.
